(19) United States
(12) Patent Application Publication
(10) Pub. No.: US 2018/0012517 A1
(43) Pub. Date: Jan. 11, 2018

(54) THREE DIMENSIONAL HINGED MODEL

(71) Applicant: WhiteClouds Inc., Ogden, UT (US)

(72) Inventors: Jerry Ropelato, Huntsville, UT (US); Joey Skinner, Morgan, UT (US); Braden D. Ellis, Logan, UT (US); Kyle Warren Gifford, South Ogden, UT (US); Athena M. Perkins, Ogden, UT (US); Heather LaCrae Perkins, Ogden, UT (US); Christopher Sean Weston, Mountain Green, UT (US)

(73) Assignee: WhiteClouds Inc., Ogden, UT (US)

(21) Appl. No.: 15/264,102

(22) Filed: Sep. 13, 2016

Related U.S. Application Data
(60) Provisional application No. 62/359,086, filed on Jul. 6, 2016.

(51) Int. Cl. G09B 23/32

(52) U.S. Cl. CPC G09B 23/32

(57) ABSTRACT

An apparatus includes a plurality of segments. The segments collectively forming a 3D hinged model of a living organ derived from a medical imaging file, and the segments are hinged together.

### CROSS-REFERENCE TO RELATED APPLICATIONS

The present application for patent claims priority to U.S. Provisional Patent Application No. 62/359,086 by Ropelato et al., entitled “Three Dimensional Hinged Model,” filed Jul. 6, 2016, the entire disclosure of which is incorporated herein by reference.

### FIELD

The present disclosure is related to models of organs and, more specifically, to hinged three-dimensional models of organs that may be used in conjunction with medical procedures.

### BACKGROUND

When planning for a surgical procedure, medical doctors and technicians often refer to two-dimensional images, such as X-rays, magnetic resonance images (MM), or computerized axial tomography (CAT) scans. By referring to these two-dimensional images, the surgeons may gain insight into how to perform the surgery. Such images may provide valuable information related to an area and anatomical features of the particular area, that may allow a surgeon to determine an effective strategy for successful completion of the surgery. For example, a surgeon may use one or more types of two-dimensional images when preparing for a surgery in which a mass or tumor is to be removed from an organ.

While two-dimensional images are useful, and often necessary, in many cases a surgeon may need to visibly observe or physically touch an organ during a procedure to determine certain aspects of the organ and tissue on which the procedure is being performed. Continuing with the above example, a surgeon may rely on actual observation or feel of organ tissue to determine an amount of tissue to remove from the organ when removing the mass or tumor. In cases where other sensitive tissue is located adjacent to the mass or tumor being removed, it may be desirable to disturb the adjacent tissue as little as possible. In some cases, an organ may be located such that visual observation or physical contact with the organ may be obstructed by other organs. Furthermore, in some cases an organ may be bleeding, which may obscure organ tissue and impair a surgeon's ability to observe tissue. Accordingly, additional surgical aids that may assist with such surgical procedures may help to enhance surgical efficiency and patient outcomes.

### SUMMARY

Various aspects of the present disclosure provide a three-dimensional (3D) hinged model that may replicate an organ. The 3D hinged model may include a number of segments that are connectable together by a hinge mechanism and that, collectively, form a 3D hinged model of a living organ. The 3D hinged model may be fabricated using 3D data that is derived from a medical imaging file for a patient, and may be used by medical personnel to plan for a procedure to be performed on the patient. The 3D hinged model may provide the ability for the medical personnel to observe a replica of the organ that, in some examples, may be operated on by a surgeon, and may allow a view of actual dimensions associated with the organ that may be helpful when operating on the actual organ. Such a 3D hinged model may be segmented to allow a cross-sectional view of a particular region of interest, such as an abnormal growth, a blood vessel, or a neuron, such that various internal aspects of the region of interest may be viewed in one or more or the segments. Such a 3D hinged model may thus provide a more tangible object than would otherwise be available using software generated images, with dimensions substantially the same as the corresponding living organ that can be studied and measured in preparation for a medical procedure.

In some examples, an apparatus is provided that includes a number of segments (e.g., slices) that collectively form a 3D hinged model of a living organ derived from a medical imaging file, and a hinge mechanism coupled with each of the segments. At least a portion of one or more of the segments may be semi-transparent or transparent, thus allowing an unobstructed view of the region of interest. In other examples, the segments are opaque. The region of interest may be colored, in some cases, to highlight an area that may be subject to the medical procedure. For example, a tumor may be colored with a first color, blood vessels or a nerve colored with a different color, other areas transparent, semi-transparent, or filled in with another color. The segments may have one or more faces that are polished (e.g., to a roughness average (RA) of 0.1 micrometers to 4.0 micrometers) to further facilitate viewing of the region of interest in those examples that include segments a transparent or semi-transparent materials.

The medical imaging file used to create the 3D hinged model may be derived from one or more medical imaging scans, such as, for example, a magnetic resonance imaging (MRI) scan, an X-ray computed tomography (CT) scan, a computerized axial tomography (CAT) scan, an ultrasound scan, other types of medical scans, or any combination thereof. In some examples, multiple different scans using multiple different scanning technologies may be combined to create the medical imaging file.

Any appropriate material may be used to create the components of the model. For example, the different segments of the 3D hinged model may be fabricated using 3D printing from a light curable resin. In some examples, the light curable resin may be cured by being heated to over 50 degrees Celsius. In other examples, the light curable resin may be cured by exposure to ultraviolet radiation. In other non-limiting examples, the material may include a gypsum based material, a plastic based material, a powder based material, a nylon based material, a light curable resin, another type of material, or combinations thereof.

The hinge mechanism, in some examples, may be provided using a flange on each segment of the 3D hinged model that are aligned and couplable to form the hinge mechanism. For example, the flanges may collectively define a bore, and a pivot rod may be inserted through the bore. Thus, each segment may be rotatable relative to other sections around the pivot rod. The pivot rod may, for example, may include an increased cross sectional thickness at a first end and be retained in the bore with an O-ring coupled with a second end. In some cases, the O-ring may be removed and the pivot rod removed from the bore, allowing individual segments of the 3D hinged model to be individually viewed. The flanges may be located on a 3D hinged model contour in an area of non-critical interest. Other hinge mechanisms may include a bore and pivot rod through a certain area of the 3D hinged model without the use of a flange or post and hole locking structures formed in different segments, to name but two examples.

Other aspects of the disclosure provide methods for fabricating a 3D hinged model for use in medical treatment of a patient. In one example, a method may include receiving 3D data representing a living organ of the patient and identifying a region of interest in the living organ. The 3D data may be derived from a medical imaging file that may be derived from one or more medical scans of the living organ. Based on the identification of the region of interest, the 3D data may be segmented into a plurality of segments, and a hinge point identified for each segment based at least in part on the region of interest (e.g., the hinge point may be located away from the region of interest). 3D data representing each segment and associated hinge point may then be generated, and each segment of the 3D hinged model may be fabricated using the 3D data. The fabricated segments may be coupled together, via the hinge point, to create the assembled 3D hinged model of the living organ. The 3D hinged model may then be used for planning for a surgery or other medical procedure to be performed on the actual living organ.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

The accompanying drawings illustrate various embodiments of the present method and system and are a part of the specification. The illustrated embodiments are merely examples of the present system and method and do not limit the scope thereof.

FIG. 1 is a top perspective view of an exemplary 3D hinged model according to the present disclosure.

FIG. 2 is a bottom perspective view of the exemplary 3D hinged model of FIG. 1.

FIG. 3 is an example of segments of an exemplary 3D hinged model rotated about a hinge point according to the present disclosure.

FIG. 4 is an exploded view of 3D hinged model segments of an example of a 3D hinged model according to the present disclosure.

FIG. 5 is an example of an alternative hinge mechanism for a 3D hinged model according to the present disclosure.

FIG. 6 is an example of another alternative hinge mechanism for a 3D hinged model according to the present disclosure.

FIG. 7 is an example of another alternative hinge mechanism for a 3D hinged model according to the present disclosure.

FIG. 8 is a perspective view of an example 3D hinged model of a different living organ according to the present disclosure.

FIG. 9 is an exploded view of the example 3D hinged model of FIG. 8.

FIG. 10 is a perspective view of an example 3D hinged model of another different living organ according to the present disclosure.

FIG. 11 is a flow chart illustrating an example of a method for fabricating a 3D hinged model according to the present disclosure.

FIG. 12 is a flow chart illustrating an example of a method for surgery planning using a 3D hinged model according to the present disclosure.

FIG. 13 is a flow chart illustrating an example of a method for generating a medical imaging file for use in creating a 3D hinged model according to the present disclosure.

Throughout the drawings, identical reference numbers designate similar, but not necessarily identical, elements. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

As discussed above, various different types of two-dimensional (2D) images may be utilized by medical doctors or technicians when planning for a surgical procedure. Such images may include, for example, X-rays, magnetic resonance images (MRI), computerized axial tomography (CAT) scans, ultrasound scans, positron emission tomography (PET) scans, tactile imaging images, photoacoustic images, thermographic images, or spectroscopic images, to name a few non-exhaustive examples. The particular type of image, or combinations of one or more types of images, may be selected based on a number of factors, such as properties of a portion of a body being imaged, the location of the portion of the body being imaged, features of interest within the body or organ, and the like. Furthermore, in many cases three-dimensional (3D) images of an organ, or portion of a body, may be generated that may be used when planning for a surgical procedure. When referring to an “organ” or “living organ” herein, it is to be understood that the term may refer to a particular organ, a portion of an organ, a group of organs, a bone or group of bones, an organ and an implant associated with the organ, an organ with an impaled object, any other body part, or any combination thereof. Such 3D images may be formed from multiple 2D images that may be combined to generate a 3D image. Furthermore, multiple different imaging modalities may be used to generate a 3D image. In many cases, available computer software may render a 3D image on a screen, and medical doctors or technicians may rotate and/or zoom on particular areas of interest through a user interface provided by the computer software.

By referring to these 2D or 3D images, surgeons or medical technicians may gain insight into how to perform a surgery or other procedure on the organ or portion of the body. Such images may provide valuable information related to an area and anatomical features of the particular area, that may allow the formulation of an effective strategy for successful completion of the surgery. For example, a surgeon may use one or more types of two-dimensional images when preparing for a surgery in which a mass or tumor is to be removed from an organ. As indicated above, various aspects of the present disclosure may use 3D images of an organ (or other portion of a body), to generate a 3D hinged model of the organ. In some examples, the 3D hinged model is fabricated in multiple segments that may be combined to form the 3D hinged model of the organ. Such a 3D hinged model may provide another valuable tool in preparing for a surgery or other medical procedure, by providing a more tangible 3D hinged model that may be studied and that provides substantially the same dimensions as the actual living organ.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. Often, the width of an object is transverse the object's length.

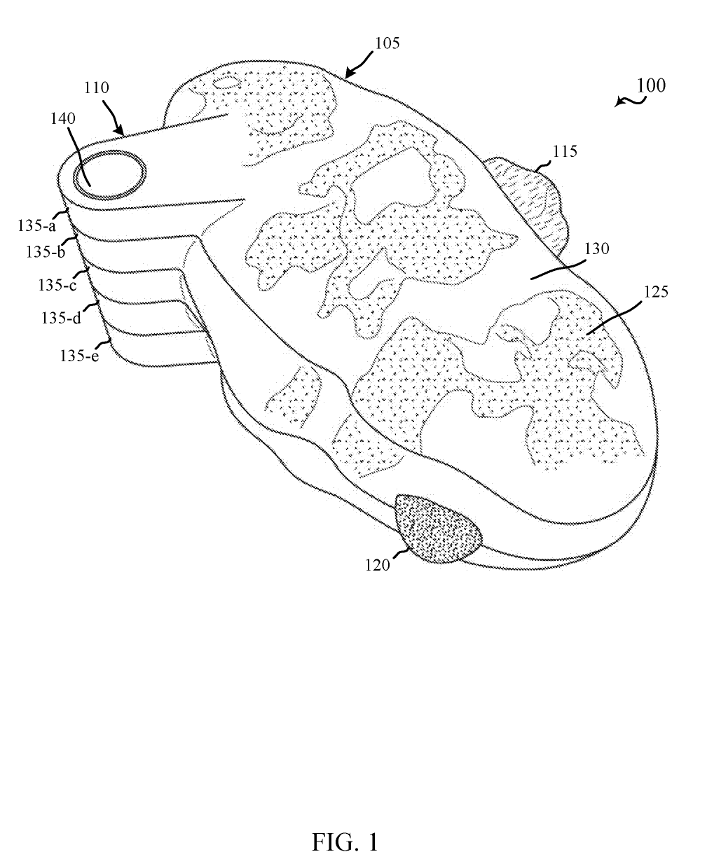

For the purposes of this disclosure, an anatomical plane generally refers to a hypothetical plane used to transect the human body. For the purposes of this disclosure, a sagittal plane generally refers to an anatomical plan that is aligned to the sagittal suture, which divides the body into left and right. For the purposes of this disclosure, a coronal plane generally refers to an anatomical plan that divides the body into dorsal and ventral portions. For the purposes of this disclosure, an axial plane generally refers to an anatomical plan that divides the body into head and tail portions. FIGS. 1-4 depict an example of a 3D hinged model 100 according to aspects of the disclosure. The 3D hinged model 100 includes an organ 105 and a hinge mechanism 110. In this example, organ 105 is a 3D hinged model of a kidney which may have abnormal growths or tumors 115 and 120 that have a first color (e.g., a blue color), and medulla 125 that have a second color (e.g., a white color). In some examples, the remaining portions 130 are transparent or semi-transparent. In other examples, the remaining portions 130 are also colored. In those examples where the material is at least semi-transparent, at least a portion of the 3D hinged model 100 may have a total optical transmittance of at least 50%. In some examples, the total optical transmittance of at least portions of the 3D hinged model 100 may be at least 95%.

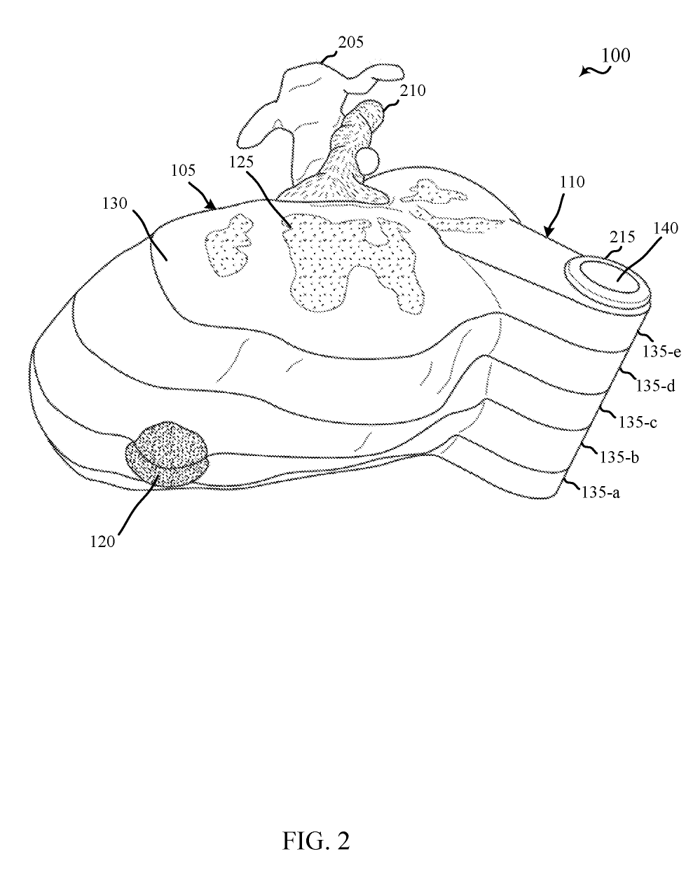

As best viewed in FIG. 2, the organ 105 in this example also has a renal artery 205 and a renal vein 210, which may have a third color (e.g., a light-blue color).

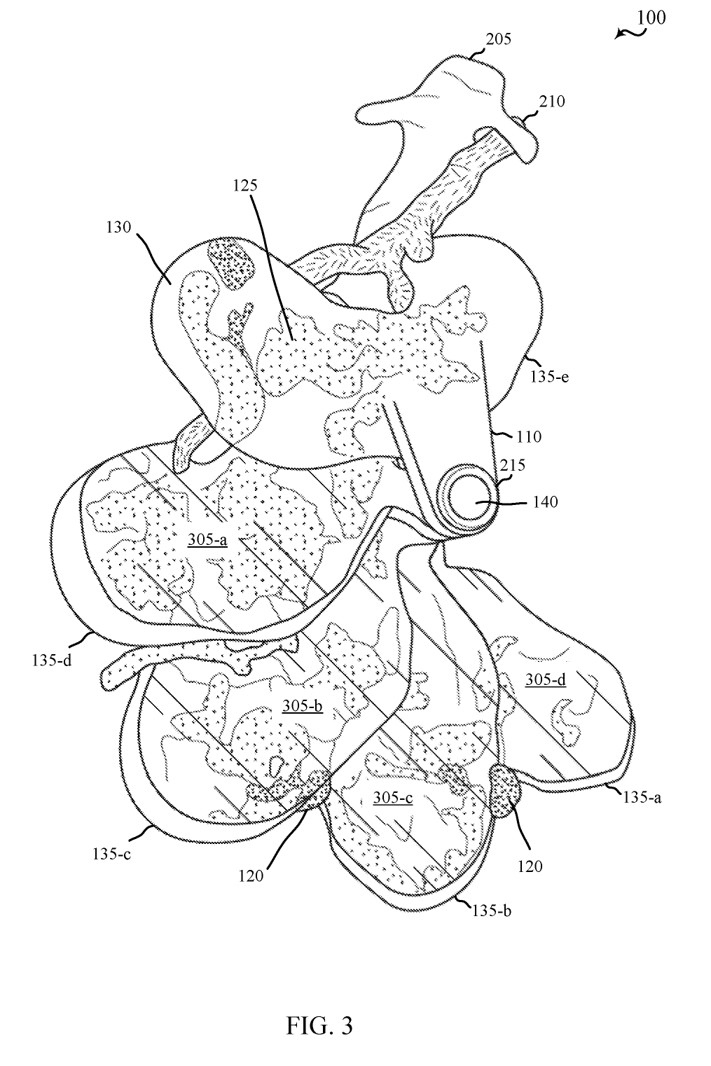

The 3D hinged model 100 is made of multiple slices 135-a through 135-e that may be fabricated individually (e.g., individually printed using a 3D printer) and represent a segment of the organ 105. The outside contour of the organ 105 corresponds to the contour of the living organ with the exception of the flanges of hinge mechanism 110 that extend away from the outside contour of each of the segments 135. While the outside of the organ 105 corresponds to the actual contour of the living organ, the inside of the model, viewable through segment faces 305 (best viewed in FIG. 3), also corresponds with the internal features of the living organ. In other words, the printed, 3D hinged model 100 is a replica of the living organ inside and out. In some cases, the printed, 3D hinged model 100 has the exact or substantially same internal and exterior dimensions as the living organ. In these examples, a surgeon or medical technician may obtain precise measurements about features and/or regions of interest, such as tumors or abnormal growths 115 and 120 that are unique to his or her patient. A surgeon or other medical personnel may obtain information by reviewing a three dimensional rendition of the patient's organ that were not revealed or at least did not stand out from the conventional approach of reviewing 2D or 3D software generated images.

The 3D hinged model 100 may be based on image files obtained through any appropriate type of medical imaging technique. For example, a non-exhaustive list of medical imaging techniques that may be used to gather the data for creating the 3D hinged model 100 include techniques such as x-rays, magnetic resonance imaging techniques, computerized axial tomography, ultrasound techniques, nuclear imagining, molecular imagining, other types of imagining, or combinations thereof. In some examples, the data from the imagining techniques is converted into a DICOM file to be interpreted with three dimensional printing software.

The DICOM file may be a file that is consistent with standards established by the Digital Imaging and Communications in Medicine Standard. These medical images may include CT scans, MRIs, and ultrasound. A DICOM file may include a header. The header may include information about the patient's name, the type of scan, and image dimensions. The DICOM file may also include image information in three dimensions, which is different from the Analyze formats that stores the image data in a .img file and the header data in .hdr file. Another difference between DICOM and Analyze files is that the DICOM image data can be compressed to reduce the image size. DICOM files can be compressed using lossy or lossless variants of the JPEG format, as well as a lossless Run-Length Encoding format.

The DICOM file or other appropriate file types can be modified to enhance the visual properties of the 3D hinged model 100 so that details about the living organ's regions of interest, such as tumors or abnormal growths 115 and 120, are easier to ascertain. This may include adding color to regions of interest in the model, as indicated above. For example, a color may be added to tumors, cysts, lesions, other types of growths, abnormalities, blood vessels, neurons, bones, adjacent organs, other types of tissues, implanted objects, impaled objects, other regions of interest, or combinations thereof.

Some other exemplary modifications between the 3D hinged model 100 and an actual living organ may include filling in internal cavities of the organ for clarity, aligning segments to improve the hinge mechanism 110 function, coloring portions of the 3D hinged model 100 to highlight the regions of interest, bridge gaps so that all geometries slightly intersect with each other, adding support structures to brace small or unsupported details, subtracting internal geometries from external geometries to enhance presentation, and intersecting the hinge 110 flange with the anatomical body of the organ for attachment.

After the DICOM file or other file type is modified, the file may be sent to a 3D printer where the 3D hinged model segments 135 are printed. Any appropriate type of printing material may be used. In one example, the 3D hinged model 100 is printed with a light curable resin although other types of materials may be used. In some cases, the 3D hinged model 100 is formed through an additive process, like three dimensional printing. But, in other examples, a subtractive process, an etching process, or other type of process may be used.

After fabricating each segment 135 of the 3D hinged model 100, post-processing to further enhance the visual characteristics of the model may be performed. In some cases, the resin is heated to an appropriate temperature (e.g., 50 degrees Celsius) to melt and/or remove waxes, residuals, or other impurities from the resin. The face of at least some of the slices may also be polished to reduce light's reflection off of the slice faces 305. Polishing may occur with a moving grit that progressively gets finer throughout the polishing process. In some examples, the polished surface includes a roughness average (RA) of 0.1 micrometers to 4.0 micrometers.

In another example, the 3D printing technique uses a white powder that is combined colored glue to bond the layers of the powder together. A thin layer of powder may be placed on a platform and a print head may spray drops of the colored glue as determined by the 3D printing program. After each layer, the platform may be lowered and a new layer of the white powder is added. The lower layers of powder act as a support for portions of the object during printing that are not connect or well supported by other portions of the partly printed object. This process may be repeated as often as necessary until the object is completed. Color may be added to the printed object by combining four different pre-colored glues to match the requested surface color.

After the object is printed, the object may be removed from the excess powder. In some cases, a portion of the excess powder may be recycled for future print jobs. In some examples, the printed object is cleaned with pressurized air to remove the remaining powder. Additional glue may be added to the printed object to strengthen the object. In some cases, a liquid finishing additive is applied to the object, which solidifies the object by filling in voids and enhances the color. In some cases, the objects can receive a varnish to add protection to light exposure.

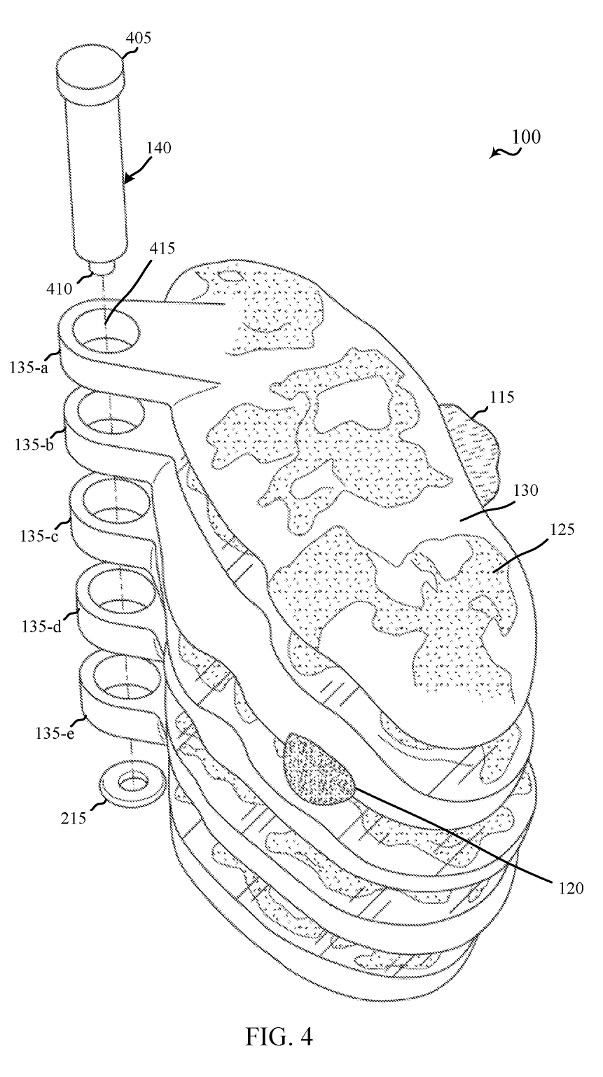

The flanges of hinge mechanism 110 printed with each of the segments 135 collectively define a bore 415, best viewed in FIG. 4. A removable pivot rod 140 can be inserted into the bore 415. The pivot rod 140 can be retained within the bore with an increased cross sectional thickness on a first end 405 of the rod. On the other end of the rod, an O-ring 215 may be secured to prevent the segments 135 from slipping and thereby retain the segments 135 on the pivot rod 140. The O-ring 215 may be removed from the pivot rod 140, and one or more of segments 135 removed in the event that a user desires to study one particular segment, such as segment 135-b, in more detail. While this example has been described with reference to a pivot rod 140 holding the slices together, any appropriate type of mechanism may be used to hold the segments 135 together, as will be discussed in more detail below.

The segments 135 may individually rotate about the pivot rod 140 as depicted in FIG. 3. As a user desires to see details internal to the living organ, the user may move the segments 135 about the pivot rod 140 to obtain a closer look. The internal details may reveal, for example, how a tumor, cyst, or other growth is interconnected to healthy issues, blood vessels, and neurons. In other examples, the internal details may reveal how a bone was shattered or the results of others types of trauma to the patient, the pressure buildup within a group of organs, a slipped or bulging disc, other details, or combinations thereof. In those examples with at least a semi-transparent section, the transparency of the 3D hinged model 100 allows a user to view through the thickness of the slices and see the regions of interest.

As indicated above, in some cases each region of interest includes a different color. The different colors may be similar colors that provide a contrast that allows the user to distinguish between regions of interest. In other examples, the colors of different regions of interest are drastically different. In some cases, the regions of interest are opaque so that the user cannot see through them. In other examples, at least one of the regions of interest includes a color that has at least some transparency.

The 3D hinged model 100 may be made of any appropriate number of slices or segments 135. The number of segments 135 may be determined based on the size of the organ 105 or number of organs, the surgical team's granularity of interest in portions of the organ 105, complex nature of the surgery, other factors, or combinations thereof.

The following is a list of factors that may be used in some cases to determine how and where to slice the 3D hinged model 100, which includes surgeon requests, optimal presentation, 3D hinged model integrity, build time, print time, print cost, build lines, other factors, or combinations thereof. The slice direction may be determined by print integrity and optimal presentation for a region of interest. The slice thickness may be determined by print integrity and optimal presentation for the region of interest. Using proper naming conventions can assist with slice geometry placement.

The flange location for the hinge mechanism 110 may be selected so that the flange is integrally formed with the organ 105, but minimally interferes with the region of interest. Thus, in the example of FIGS. 1-4, the hinge mechanism 110 may include a flange that is located away from tumors or abnormal growths 115 and 120. The flange location and placement may also be determined based on the amount of clearance desired for removing the pivot rod 140, the pivot rod 140 shape and design, slice alignment, other factors, or combinations thereof. In some cases, the flanges for the pivot rod 140 may be placed on an opposite side of regions of interest.

The pivot rod 140 may be any appropriate length, thickness, and/or shape. In some examples, the pivot rod 140 has a generally circular cross section. In other examples, the pivot rod may include a generally rectangular cross section, a generally triangular cross section, a generally square cross section, an asymmetric cross section, another type of cross section, or combinations thereof. Further, the pivot rod may be generally straight along its length, curved along its length, or combinations thereof. In some cases, the 3D hinged model includes more than one hinged region. The second hinged region may be directed in a different orientation than the first hinged region.

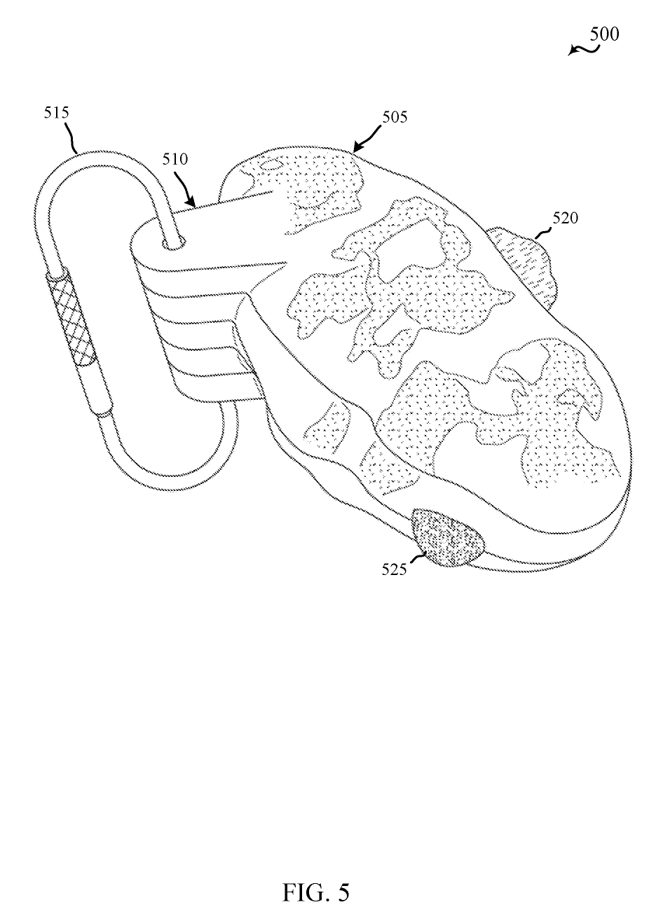

FIGS. 5-7 illustrate several alternative hinge mechanisms of different examples. In the example 500 of FIG. 5, an organ 505 may have abnormal growths or tumors 520 and 525. Hinge mechanism 510 may include a flange with a through hole, and in this example includes a looped rod 515. Segments of organ 505 may rotate about the looped rod 515 or may be moved around the looped rod 515 to allow inspection of a particular section of interest.

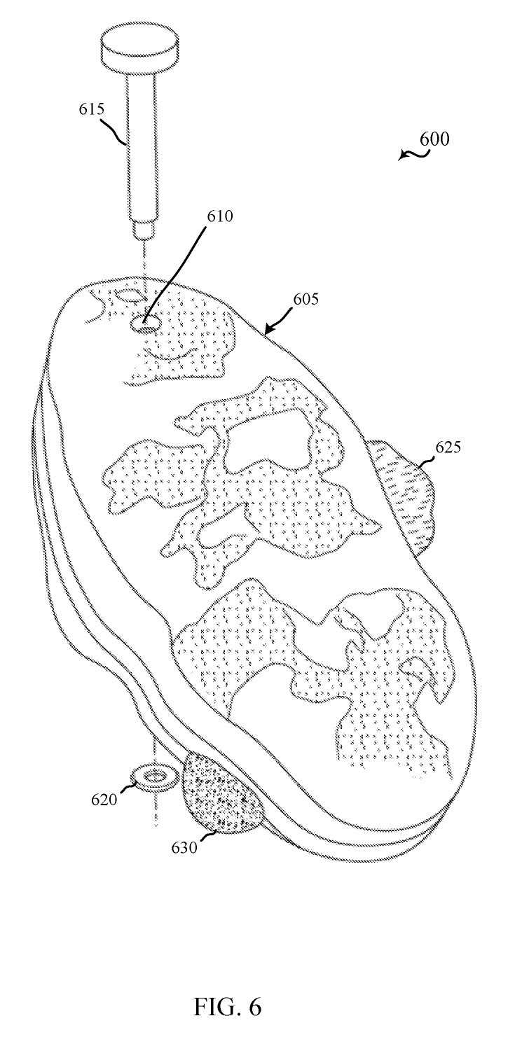

In the example 600 of FIG. 6, an organ 605 may have abnormal growths or tumors 625. Hinge mechanism 610 may include a through hole in each segment of organ 605, through which a pivot rod 615 may be inserted. An O-ring 620 may be placed over an end of the pivot rod 615 to keep the segments of the organ 605 on the pivot rod 615.

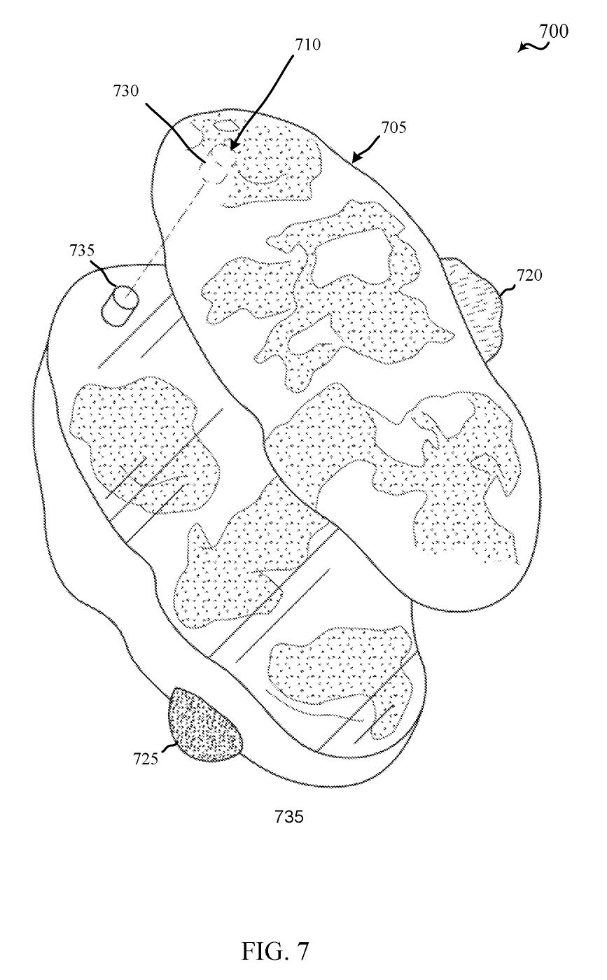

In the example 700 of FIG. 7, an organ 705 may have abnormal growths or tumors 720 and 725. Hinge mechanism 710 may include a recessed region 730 in a first side of a segment and a protruding portion 735 of a second side of the segment, where the recessed region 730 can receive the protruding portion 735 of an adjacent flange. These adjacent flanges may snap together while still allowing a user to rotate the slices relative to one another.

While the examples above provide various different hinge mechanisms for holding the slices of the 3D hinged model together, any appropriate hinged structure may be used. Furthermore, while the examples above have been described with 3D hinged model segments made of slices, any appropriate 3D hinged model segment may be used. For example, the segments may include just a portion of the organ's cross section. In other examples, the segments may be generally triangular shaped, generally square shaped, generally cone shaped, generally arc shaped, generally asymmetric, another shape, or combinations thereof.

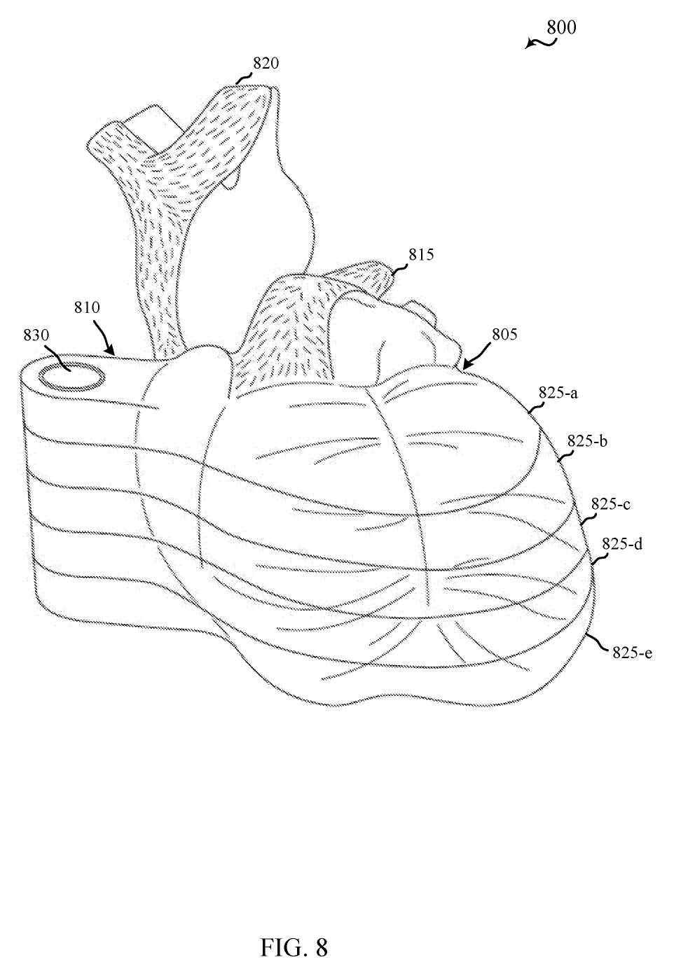

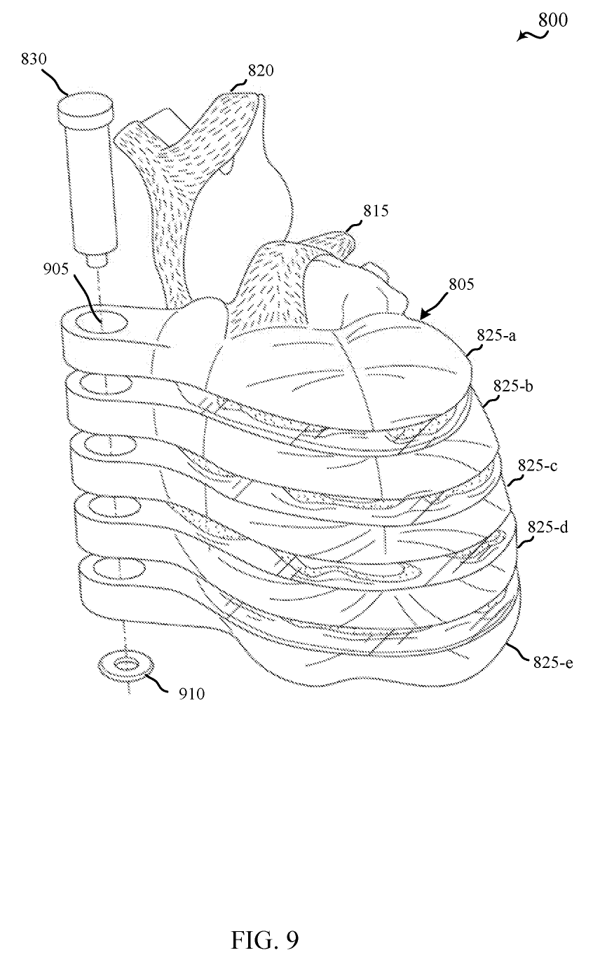

Additionally, while FIGS. 1-7 illustrate a kidney, techniques described herein are also applicable to numerous other body parts or organs. FIGS. 8-10 illustrate different exemplary organs that may have 3D hinged models fabricated for use in a medical procedure. In the example of FIGS. 8-9, a 3D hinged model 800 that includes a heart 805 and hinge mechanism 810 is illustrated. In this example, regions of interest may include arteries 815 and 820, which may be fabricated in a different color similarly as discussed above. Segments 825-a through 825-e may be fabricated and assembled in a manner as discussed herein. Hinge mechanism may include flanges with a through hole 905, that may receive a pivot rod 830 and be secured with an O-ring 910. Such a 3D hinged model may be used, for example, in preparation for a heart procedure, such as a coronary bypass surgery or a valve replacement surgery.

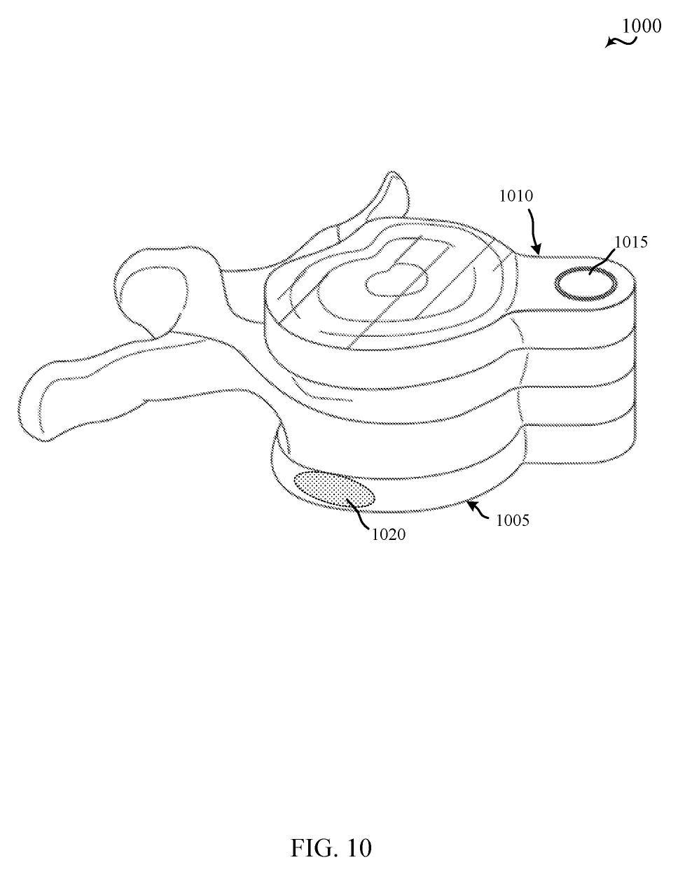

In the example of FIG. 10, a 3D hinged model 1000 that includes a portion of a spine 1005 and hinge mechanism 1010 is illustrated. In this example, regions of interest may include a portion of a disk 1020, such as a bulging disc 1020, which may be fabricated in a different color similarly as discussed above. The spine 1005 portion may be segmented, similarly as discussed above, and may be fabricated and assembled in a manner as discussed herein. Hinge mechanism 1010 may include flanges with a through hole that may receive a pivot rod 1015, similarly as discussed above. Such a 3D hinged model may be used, for example, in preparation for a spinal procedure. While two additional examples are illustrated in FIGS. 8-10, as mentioned above, 3D hinged models and techniques described herein may also be used for any of a number of different organs or body parts where a 3D replica of the organ or body part may help facilitate the planning for a medical procedure.

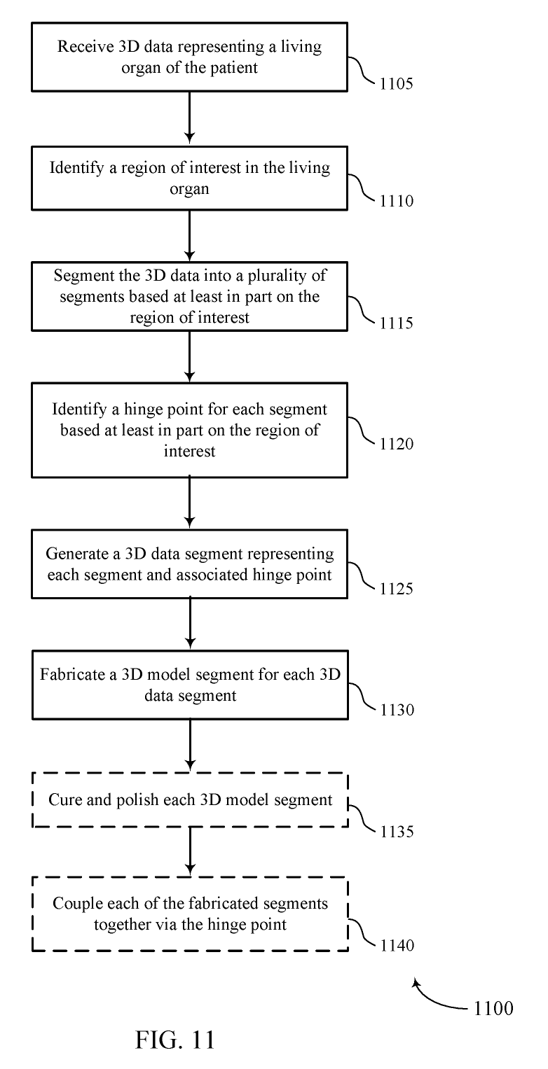

FIG. 11 is a flow chart that illustrates a method 1100 of fabricating a 3D hinged model in accordance with various aspects of the disclosure. The method 1100 of FIG. 11 may be used to fabricate 3D printed models 100, 500, 600, 700, 800, or 1000 of FIGS. 1-10, for example. Initially, at block 1105 3D data representing a living organ of a patient may be received. The 3D data may be derived, as discussed above, from one or more medical images of the patient using one or more different imaging modalities.

At block 1110, a region of interest is identified in the living organ. The region of interest, as discussed above, may be an abnormal growth or tumor, a broken bone, a bulging disc, or any other portion of an organ or body part to be subject to a medical procedure. In some examples, the region of interest may be identified by highlighting the region in the 3D data, such as through selection of the area in a software application used to generate the 3D data.

At block 1115, the 3D data is segmented into a plurality of segments based at least in part on the region of interest. In some examples, the segments may be slices of the organ or other body parts, and the data may be segmented by identifying a number of cross-sections in the 3D data, each cross section defining opposing faces of adjacent segments. In some examples, the particular location of one or more cross sections may be selected to provide a desired view of the region of interest.

At block 1120, a hinge point is identified for each segment based at least in part on the region of interest. Similarly as discussed above, the hinge point may be selected to be away from the region of interest, in order to enhance the visibility of the region of interest within one or more of the segments. In some examples, the hinge point may be selected at a point relative to the organ in the 3D data, and a flange with a through hole may be added to each segment to provide the selected hinge point.

At block 1125, a 3D data segment is generated representing each segment and associated hinge point. In some examples, the software application used to generate the 3D data may output separate 3D data segments for each segment in a file that may be used by a 3D printer to 3D print each segment.

At block 1130, a 3D model segment is fabricated for each 3D data segment. The 3D model segments may be fabricated, as discussed above, using 3D printing, or other additive or subtractive fabrication techniques. As discussed above, regions of interest, and/or other areas of the organ may be colored differently during the fabrication process to provide visibility into the organ and the region of interest. In some examples, remaining portions of the organ may be fabricated from transparent or semi-transparent material so as to provide visibility to the region(s) of interest.

At optional block 1135, each 3D model segment is cured and polished. In some examples, the segments are cured at a temperature in excess of 50 degrees Celsius, to harden a light curable resin used for the fabrication of each model segment. Faces of each 3D model segment may be polished to enhance visibility of features within the segment. Polishing may occur with a moving grit that progressively gets finer throughout the polishing process. In some examples the polished surface includes a roughness average (RA) of 0.1 micrometers to 4.0 micrometers.

At optional block 1140, each of the fabricated segments may be coupled together via the hinge point. In some examples, the segments may be coupled together using a pivot rod or other hinge mechanism, as discussed above.

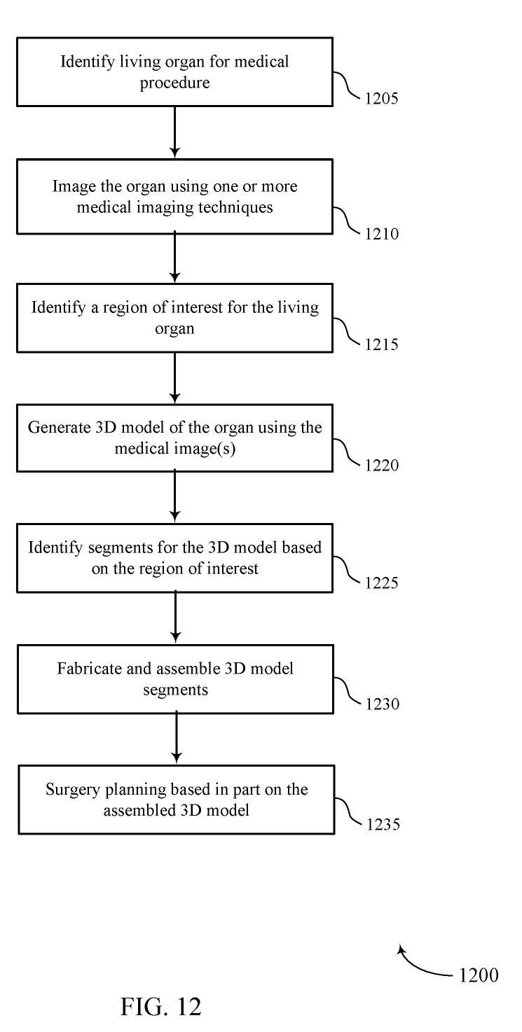

FIG. 12 is a flow chart that illustrates a method 1200 of surgery planning using a 3D hinged model in accordance with various aspects of the disclosure. The method 1200 of FIG. 12 may utilize 3D printed models 100, 500, 600, 700, 800, or 1000 of FIGS. 1-10, for example.

At block 1205, a living organ is identified for medical procedure. Such an identification may be made through a medical diagnostic procedure, where the organ is identified as needing a medical procedure.

At block 1210, the organ is imaged using one or more medical imaging techniques. Such images may include, for example, X-rays, magnetic resonance images (MRI), computerized axial tomography (CAT) scans, ultrasound scans, positron emission tomography (PET) scans, tactile imaging images, photoacoustic images, thermographic images, or spectroscopic images, to name a few non-exhaustive examples.

At block 1215, a region of interest for the living organ is identified. Such a region of interest may be, for example, a tumor, an abnormal growth, an inflamed or infected area, a broken bone, an abnormality, or condition that is to be addressed in the medical procedure.

At block 1220, a 3D model of the organ is generated using the medical image(s). The 3D model may be generated, for example, through combining multiple images from one or more different imaging techniques.

At block 1225, segments for the 3D model are identified based on the region of interest. In some examples, the segments may be slices of the organ or other body part, and the data may be segmented by identifying a number of cross-sections. In some examples, the particular location of one or more cross sections may be selected to provide a desired view of the region of interest.

At block 1230, different 3D model segments are fabricated and assembled. The fabrication may include, in some examples, 3D printing each segment, curing each segment, and polishing each segment. The fabrication may also include providing data files associated with each segment to be used for fabrication of the segments. The segments may be assembled, in some examples, by connecting segments using a hinge mechanism, as discussed above.

At block 1235, surgery planning is performed based in part on the assembled 3D model. Such surgery planning may include, for example, identifying measurements or relative distances for different features of the organ, identifying how different features of the organ are entangled, identifying where parts of the organ are located, and the like. Thus, such a 3D printed model may provide another tool that may be used to assist a surgeon to perform a successful surgical procedure.

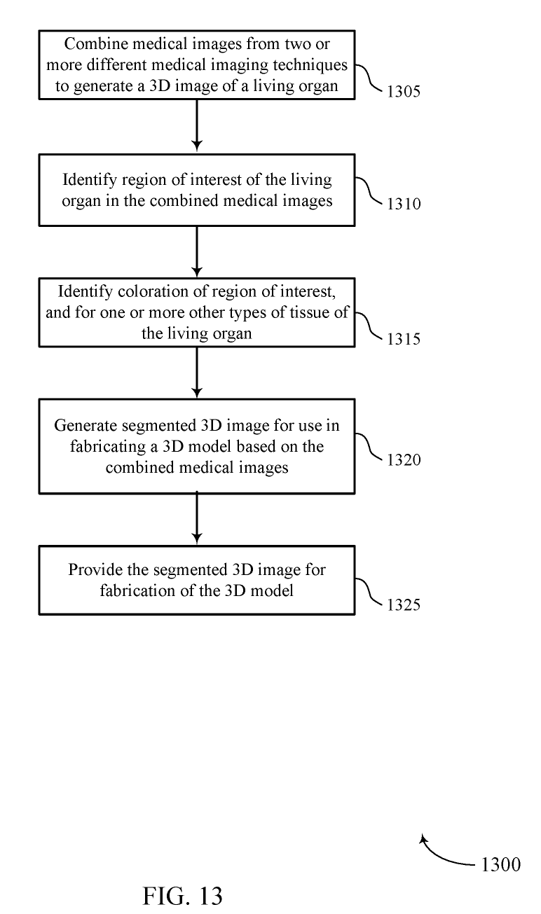

FIG. 13 is a flow chart that illustrates a method 1300 of generating a medical imaging file for fabricating a 3D hinged model in accordance with various aspects of the disclosure. The method 1300 of FIG. 13 may be used to provide a medical imaging file used to fabricate 3D printed models 100, 500, 600, 700, 800, or 1000 of FIGS. 1-10, for example.

At block 1305, medical images from two or more different medical imaging techniques may be combined to generate a 3D image of a living organ. As discussed above, such images may include, for example, X-rays, MM images, CAT scans, ultrasound scans, PET scans, tactile imaging images, photoacoustic images, thermographic images, or spectroscopic images, to name a few non-exhaustive examples. The images may be combined using a software application that may combine imagery from the two or more different imaging techniques to provide an enhanced view of the living organ.

At block 1310, a region of interest of the living organ is identified in the combined medical images. The region of interest, as discussed above, may be an abnormal growth or tumor, a broken bone, a bulging disc, or any other portion of an organ or body part to be subject to a medical procedure. In some examples, the region of interest may be identified by highlighting the region in the 3D data, such as through selection of the area in a software application used to generate the 3D data.

At block 1315, a coloration of the region of interest, and for one or more other types of tissue of the living organ, is identified. Such a coloration may be selected to provide enhanced viewing or contrast associated with the region of interest, as discussed above.

At block 1320, a segmented 3D image is generated for use in fabricating a 3D model based on the combined medical images. In some examples, the segments may be slices of the organ or other body part, and the data may be segmented by identifying a number of cross-sections in the 3D data, each cross section defining opposing faces of adjacent segments. In some examples, the particular location of one or more cross sections may be selected to provide a desired view of the region of interest.

At block 1325, the segmented 3D image is provided for fabrication of the 3D model. In some examples, separate data files associated with each segment to be used for fabrication of the segments are provided. The segments may be fabricated and assembled based on the segmented 3D image, in a manner as discussed above.

Any appropriate type of 3D printing technique may be used in accordance with the principles described in the present disclosure. For example, a list of non-limiting 3D printing techniques that may be compatible with the principles described herein include fused deposition modeling techniques, extrusion techniques, fused filament fabrication techniques, direct ink writing techniques, stereo lithography techniques, digital light processing techniques, powder bed techniques, inkjet head printing techniques, electron beam melting techniques, selective laser melting techniques, selective heat sintering techniques, selective laser sintering techniques, direct metal laser sintering techniques, laminated object manufacturing techniques, direct energy deposition techniques, electron beam freeform fabrication techniques, other 3D printing techniques, or combinations thereof.

Further, any appropriate type of material may be used in accordance with the principles described herein. For example, a non-limiting list of materials that may be compatible with the principles described herein include: nylon powders, gypsum powders, plastics, acrylic plastics, ultraviolet light curable resins, thermoplastics, eutectic metals, rubber, modeling clay, ceramic materials, metal alloys, cermet, metal matrix composition, ceramic matrix composite, photopolymers, powder polymers, titanium alloys, cobalt chrome alloys, stainless steel, aluminum, thermoplastic powder, paper, metal foil, plastic film, other materials, or combinations thereof.

In some examples, companies that custom make the model may provide a surgeon or other users models with varying options. For example, the user may request that the model include at least one transparent section, at least one opaque section, varying thicknesses of the slices, types of colors, the angle of the slice cuts, the amount of tissue surrounding the point of interest, other options, or combinations thereof.

In some examples, the slices are sagittal slices that have a slice surface aligned along a sagittal plane of the organ. In other examples, the slices are coronial slices that have a slice surface aligned along a coronial plane of the organ. In yet another example, the slices are axial slices that have a slice surface aligned along an axial plane of the organ. In some circumstances, the slices are oriented to be aligned with the anatomical plane (sagittal, coronial, or axial) used in the medial image file. In yet other examples, the slices are oriented to be orthogonal to the anatomical plane used in the medial image file. In some examples, the markers, words, symbols, or other types of indicators may be included on the hinge or other portions of the model. For example, a measurement scale may be included on the hinge and may provide markings that indicate the thickness of each segment or slice, the distance between points of interest, or other dimensions.

The technology disclosed herein is described with reference to certain exemplary embodiments. The word “exemplary” is used herein to mean “serving as an example, instance, or illustration.” Any embodiment described herein as “exemplary” is not necessarily to be construed as preferred or advantageous over other embodiments absent a specific indication that such an embodiment is preferred or advantageous over other embodiments. Moreover, in certain instances only a single “exemplary” embodiment is provided. A single example is not necessarily to be construed as the only embodiment. The detailed description includes specific details for the purpose of providing a thorough understanding of the technology of the present patent application. However, on reading the disclosure, it will be apparent to those skilled in the art that the technology of the present patent application may be practiced with or without these specific details. In some descriptions herein, generally understood structures and devices may be shown in block diagrams to aid in understanding the technology of the present patent application without obscuring the technology herein. In certain instances and examples herein, the term “coupled” or “in communication with” means connected using either a direct link or indirect data link as is generally understood in the art.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An apparatus, comprising:
a plurality of segments;
the segments collectively forming a 3D hinged model of a living organ derived from a medical imaging file; and
a hinge mechanism coupled with each of the plurality of segments.

2. The apparatus of claim 1, wherein at least a portion of one or more of the segments is semi-transparent or transparent.

3. The apparatus of claim 2, wherein at least a portion of one or more of the segments has a total optical transmittance of at least 50%.

4. The apparatus of claim 2, wherein the segments include a characteristic of having a total optical transmittance of at least 95%.

5. The apparatus of claim 1, wherein the medical imaging file is a derived from a magnetic resonance imaging (MRI) scan, an X-ray computed tomography (CT) scan, a computerized axial tomography (CAT) scan, an ultrasound scan, or any combination thereof.

6. The apparatus of claim 1, wherein at least one of the segments includes a colored component that represents a region of interest in the living organ.

7. The apparatus of claim 6, wherein the region of interest includes one or more of a blood vessel, a neuron, or an abnormal growth, and wherein the region of interest includes substantially same dimensions as a corresponding region in the living organ.

8. The apparatus of claim 1, wherein segments are slices of the model.

9. The apparatus of claim 8, wherein at least one of the slices includes a slice face and the slice face includes a polished surface.

10. The apparatus of claim 9, wherein the polished surface includes a roughness average (RA) of 0.1 micrometers to 4.0 micrometers.

11. The apparatus of claim 1, wherein the segments are formed from a light curable resin.

12. The apparatus of claim 11, wherein the light curable resin has a characteristic of being heated to over 50 degrees Celsius.

13. The apparatus of claim 1, wherein each segment of the plurality of segments comprises:
a flange; and
a portion of the 3D hinged model of the living organ, and wherein the flanges from each of the segments are aligned.

14. The apparatus of claim 13, wherein the flanges of the plurality of segments are couplable to form the 3D hinged model of the living organ.

15. The apparatus of claim 14, wherein the flanges collectively define a bore, and wherein the apparatus further comprises:
a pivot rod disposed within the bore.

16. The apparatus of claim 15, wherein the pivot rod includes an increased cross sectional thickness at a first end and is retained in the bore with an O-ring.

17. The apparatus of claim 13, wherein the flanges are located on a 3D hinged model contour in an area of non-critical interest.

18. The apparatus of claim 1, wherein at least one of the segments is oriented to be aligned with an anatomical plane used in the medical imaging file.

19. The apparatus of claim 1, wherein at least one of the segments is transversely oriented with an anatomical plane used in the medical imaging file.

20. A method for fabricating a three-dimensional (3D) hinged model for use in medical treatment of a patient, comprising:
receiving 3D data representing a living organ of the patient;
identifying a region of interest in the living organ;
segmenting the 3D data into a plurality of segments based at least in part on the region of interest;
identifying a hinge point for each segment based at least in part on the region of interest;
generating a 3D data segment representing each segment and associated hinge point;
fabricating a 3D hinged model segment for each 3D data segment.

21. The method of claim 20, further comprising:
coupling each of the fabricated segments together via the hinge point of each of the segments to create an assembled 3D hinged model of the living organ.

22. The method of claim 20, wherein the 3D data is derived from a medical imaging file that is derived from a magnetic resonance imaging (MRI) scan, an X-ray computed tomography (CT) scan, a computerized axial tomography (CAT) scan, an ultrasound scan, or any combination thereof.

23. The method of claim 20, wherein the segmenting comprises:
identifying one or more cross-sections of the 3D data that are adjacent to or intersect the region of interest; and
dividing the 3D data into segments of 3D data based at least in part on the one or more identified cross-sections.

24. The method of claim 20, wherein the fabricating comprises:
transmitting each 3D data segment to a 3D printer;
3D printing each 3D data segment using a first colored light curable resin for the region of interest and a transparent or semi-transparent light curable resin for at least some regions of other than the region of interest;
curing each 3D printed segment; and
polishing one or more surfaces of each 3D printed segment.

25. The method of claim 20, wherein identifying the hinge point comprises:
identifying a distance around the region of interest that provides an unobstructed view of the region of interest; and
selecting a point outside of the distance around the region of interest as the hinge point.

26. The method of claim 20, wherein identifying the hinge point further comprises:
adding a flange to the 3D data for each segment based at least in part on the identified hinge point.

27. The method of claim 20, wherein the region of interest includes one or more of a blood vessel, a neuron, or an abnormal growth.
